(19) United States
(12) Patent Application Publication
(10) Pub. No.: US 2006/0080806 A1
(43) Pub. Date: Apr. 20, 2006

(54) Hinge assembly

(75) Inventor: James A. Johnson, New Hope, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Airlift Doors, Inc.

(21) Appl. No.: 10/966,934

(22) Filed: Oct. 15, 2004

(51) Int. Cl. E05D 5/02

(52) U.S. Cl. 16/387

(57) ABSTRACT

A hinge assembly includes a first base plate, a second base plate, and a riser. The second base plate is pivotally coupled to the first base plate about a pivot axis and the riser extends from a surface of one of the first base plate and the second base plate. The riser defines a plurality of apertures such that each of the apertures is offset from the pivot axis and spaced a different distance from the surface of the one of the first base late and the second base plate.

### BACKGROUND

The present invention relates generally to a hinge assembly, and more particularly to a hinge assembly attachable to a retractable or sectional door.

Doors, and in particular retractable or sectional doors, can be employed in a variety of environments including cabinets, delivery vehicles, and within garage doorways. A retractable or sectional door may include a number of vertically stacked horizontal panels positioned within the doorway. The panels are interconnected so as to permit the panels to fold or pivot along horizontal divisions formed between adjacent panels thereby facilitate opening and closing of the door. Adjacent panels are typically interconnected with hinge assemblies positioned at the center and outer edges of the panels.

Often, a retractable or sectional door will span a doorway and is supported by opposing tracks positioned on opposite sides of the doorway. To support the door within the doorway, the hinge assemblies provided at the outer edges of the panels often include guide rollers arranged to travel within the tracks during the opening and closing of the door.

The opposing tracks of the doorway may include a vertical section, a horizontal section, and a curved section transitioning between the vertical section and the horizontal section. Typically, the vertical sections of the track are tilted slightly inward such that an upper end of the vertical sections of the track are spaced further from or further within the doorway than a lower end of the vertical sections. As such, the panels of the door travel upward and slightly inward during opening of the door. This inward travel of the panels helps minimize binding of the panels and scraping of the panels against the doorway as the door is opened.

Since the door is typically positioned substantially vertically within the doorway and the vertical sections of the track tilt slightly inward, upper panels of the door are offset or spaced further from the track than lower panels of the door. As such, the offset varies between a minimum amount and a maximum amount from the lower most panel of the door to the upper most panel of the door. Often, to accommodate this varying offset, different hinge assemblies each designed to support a guide roller with a different offset spacing are employed. Thus, multiple hinges each of a different configuration are required when assembling the door within the doorway.

Accordingly, it is desirable for a common universal hinge assembly that can accommodate multiple offset spacings.

### SUMMARY

One aspect of the present invention is related to a hinge assembly. The hinge assembly includes a first base plate, a second base plate, and a riser. The second base plate is pivotally coupled to the first base plate about a pivot axis. The riser extends from a surface of one of the first base plate and the second base plate and defines a plurality of apertures. In this regard, each of the apertures is offset from the pivot axis and spaced a different distance from the surface of the one of the first base plate and the second base plate.

Another aspect of the present invention is related to a hinge assembly adapted to support a guide roller. The hinge assembly includes a first base plate, a second base plate pivotally coupled to the first base plate about a pivot axis, and means for supporting the guide roller in one of a plurality of positions each offset from the pivot axis and spaced a different distance from one of the first base plate and the second base plate.

Another aspect of the present invention is related to a guide roller assembly. The guide roller assembly includes a base plate, a riser, and a guide roller. The riser extends from a surface of the base plate and defines a plurality of apertures, and each of the apertures is offset a different distance from the surface of the base plate. The guide roller includes a guide roller pin and a guide roller wheel supported by the guide roller pin. In this regard, each of the apertures is adapted to selectively receive the guide roller pin of the guide roller.

Another aspect of the present invention is related to a method of supporting a multi-panel door. The method includes providing a first guide roller assembly and a second guide roller assembly each including at least one base plate and at least a first aperture and a second aperture each offset a different distance from the at least one base plate. The method additionally includes supporting a first guide roller in the first aperture of the first guide roller assembly and securing the at least one base plate of the first guide roller assembly to a first panel of the multi-panel door. The method further includes supporting a second guide roller in the second aperture of the second guide roller assembly and securing the at least one base plate of the second guide roller assembly to a second panel of the multi-panel door.

### BRIEF DESCRIPTION OF THE DRAWINGS

FIG. 1 is a perspective view of a hinge assembly according to one embodiment of the present invention.

FIG. 2 is a side view of the hinge assembly shown in FIG. 1.

FIG. 3 is a side view of a hinge assembly according to another embodiment of the present invention.

FIG. 4 is a perspective view of a hinge assembly according to another embodiment of the present invention.

FIG. 5 is a perspective view of a door assembly include hinge assemblies according to one embodiment of the present invention.

FIG. 6A is a perspective view of a guide roller assembly according to one embodiment of the present invention.

FIG. 6B is a perspective view of a guide roller assembly according to another embodiment of the present invention.

FIG. 7 is a cross-sectional view of the door assembly shown in FIG. 5.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

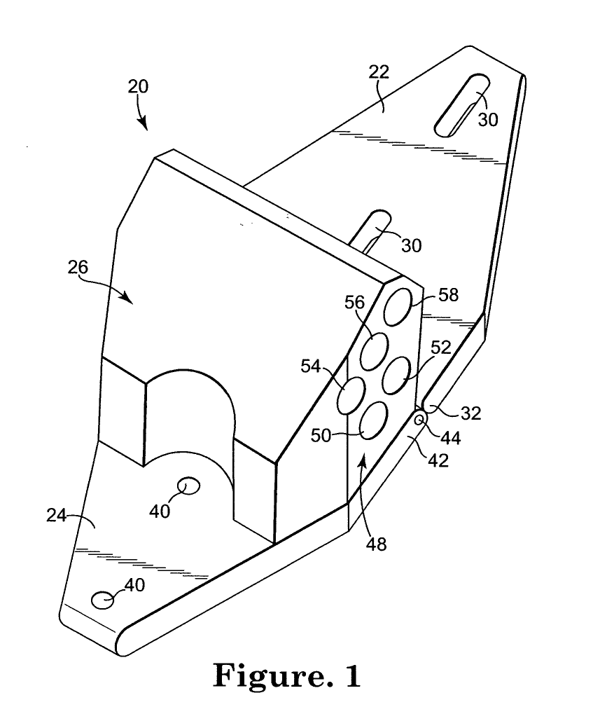

A perspective view of a hinge assembly according to one embodiment of the present invention is shown at 20 in FIG. 1. In one embodiment, the hinge assembly 20 includes a first base plate 22, a second base plate 24, and a riser 26.

In one embodiment, the first base plate 22 includes at least one mounting hole 30. In one exemplary embodiment, the first base plate 22 includes two mounting holes 30, as illustrated in FIG. 1. The mounting hole 30 can be a round hole or a through-slot adapted to receive a mounting bolt or other fastener (not shown). In addition, the first base plate 22 also includes a first end 32 configured for coupling to the second base plate 24. In one embodiment, the first end 32 is an articulated scarf end 32 defining projections adapted to accept a hinge pin 44, as described below.

In one embodiment, the second base plate 24 includes at least one mounting hole 40. In one exemplary embodiment, the second base plate 24 includes two mounting holes 40, as illustrated in FIG. 1. The mounting hole 40 can be a round hole or a through-slot adapted to receive a mounting bolt or other fastener (not shown). In addition, the second base plate 24 includes a second end 42 adapted for coupling to the first end 32 of the first base plate 22.

In one embodiment, the second end 42 is an articulated scarf end 42 defining projections adapted to mate with the projections of the first scarf end 32. In this regard, the first end 32 of the first base plate 22 is configured to pivotally couple to the second end 42 of the second base plate 24 about a pivot axis coinciding with the hinge pin 44.

In one embodiment, hinge pin 44 is employed to pivotally couple the first end 32 of the first base plate 22 to the second end 42 of the second base plate 24. The hinge pin 44 can be any bolt or pin or rod adapted to pivotally couple the first end 32 to the second end 42.

In one embodiment, as illustrated in FIG. 1, the riser 26 defines an array 48 of apertures. Specifically, in one exemplary embodiment, the riser 26 defines an array 48 of apertures including a first aperture 50, a second aperture 52, a third aperture 54, a fourth aperture 56, and a fifth aperture 58. While the riser 26 is illustrated as defining five apertures 50, 52, 54, 56, and 58, it should be understood that the riser 26 could define an array 48 of apertures including any number of apertures. For example, in one embodiment, the riser 26 defines two apertures and, in another embodiment, the riser 26 defines four apertures. In any regard, the riser 26 defines the array 48 of apertures such that a center of each of the apertures 50, 52, 54, 56, and 58 is offset laterally and longitudinally from the pivot axis, as more fully described below.

FIG. 1 illustrates apertures 50, 52, 54, 56, and 58 formed through the riser 26 such that each of the apertures 50, 52, 54, 56, and 58 includes a respective longitudinal axis that is spaced from, and oriented substantially parallel with, the pivot axis. With this in mind, the longitudinal axis of each of the apertures 50, 52, 54, 56, and 58, defines a sleeve projecting through the riser 26. Specifically, a respective longitudinal axis of each of the apertures 50, 52, 54, 56, and 58 traverses a width of the riser 26 and is substantially parallel to the pivot axis.

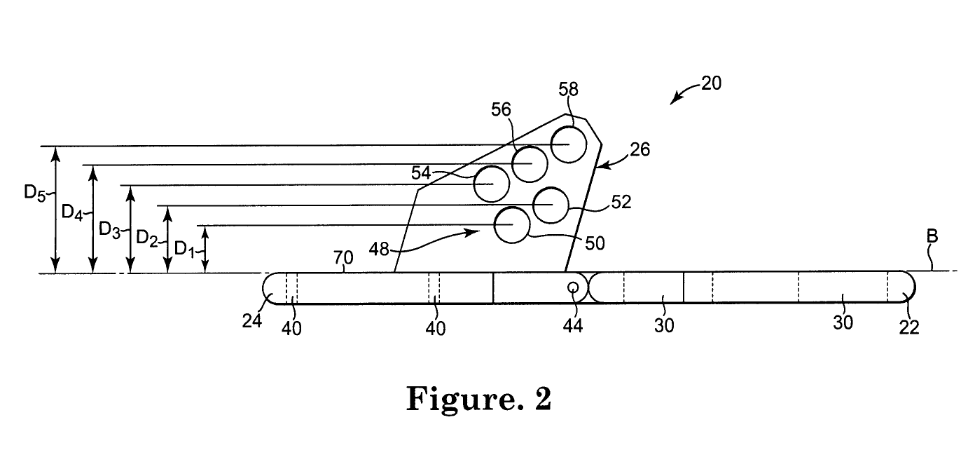

FIG. 2 is a side view of one embodiment of the hinge assembly 20. The riser 26 extends from a surface 70 of the second base plate 24. The riser 26 defines the array 48 of apertures such that each of the apertures 50, 52, 54, 56, and 58 is offset a different distance from the second base plate 24.

In one embodiment, a horizontal plane B is defined that extends from the surface 70 of the second base plate 24. As such, the aperture 50 is offset from the plane B by a first distance D1, the aperture 52 is offset from the plane B by a second distance D2, the aperture 54 is offset from the plane B by a third distance D3, the aperture 56 is offset from the plane B by a fourth distance D4, and the aperture 58 is offset from the plane B by a fifth distance D5. In one exemplary embodiment, D5>D4>D3>D2>D1 such that each of the apertures 50, 52, 54, 56, and 58 is offset a different distance from the surface 70, including, more specifically, the horizontal plane B.

In one embodiment, the apertures 50, 52, 54, 56, and 58 are each laterally offset from the pivot axis. In one exemplary embodiment, the apertures 50, 52, 54, 56, and 58 are oriented in a staggered alignment such that each of the apertures 50, 52, 54, 56, and 58 are offset from the pivot axis and offset a different distance from the surface 70 of the base plate 24. In another exemplary embodiment, one or more of the apertures 50, 52, 54, 56, and 58 are vertically aligned and offset a different distance from the surface 70 of the base plate 24.

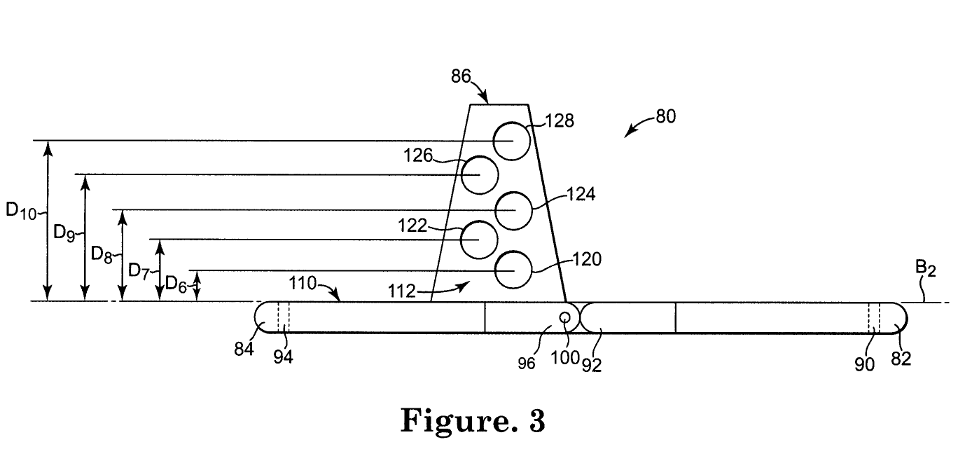

A side view of a hinge assembly 80 according to another embodiment of the present invention is illustrated in FIG. 3. In one embodiment, the hinge assembly 80 includes a first base plate 82, a second base plate 84, and a riser 86.

In one embodiment, in a manner similar to that described above with reference to first base plate 22, the first base plate 82 includes at least one mounting hole 90 and a first end 92. The mounting hole 90 can be a round hole or a through-slot adapted for receiving a mounting bolt or other fastener (not shown). The first end 92 is configured for coupling to the second base plate 84. In one embodiment, the first end 92 is an articulated scarf end 92 defining projections adapted to accept a hinge pin 100.

In one embodiment, in a manner similar to that described above with reference to second base plate 24, the second base plate 84 includes at least one mounting hole 94 and a second end 96. The mounting hole 94 can be a round hole or a through-slot adapted for receiving a mounting bolt or other fastener (not shown). The second end 96 is adapted for coupling to the first end 92 of the first base plate 82. In one embodiment, the second end 96 is an articulated scarf end 96 defining projections adapted to mate with the projections of the articulated scarf end 92 of the first base plate 82. In this regard, the first end 92 pivotally couples to the second end 96 about a pivot axis coinciding with the hinge pin 100.

In one embodiment, the riser 86 extends from a surface 110 of the second base plate 84 and defines an array 112 of apertures. In one exemplary embodiment, the array 112 of apertures includes a first aperture 120, a second aperture 122, a third aperture 124, a fourth aperture 126, and a fifth aperture 128. In one embodiment, the array 112 of apertures defines at least two apertures

In one exemplary embodiment, the array 112 of apertures is configured such that a center of each of the apertures 120, 122, 124, 126, and 128 is offset a different distance from the surface 110. By way of illustration, a horizontal plane B2 is defined that extends from the surface 110, and the apertures 120, 122, 124, 126, and 128 are each offset a different distance from the plane B2. For example, in one exemplary embodiment, the first aperture 120 is offset from the plane B2 by a distance D6, the second aperture 122 is offset from the plane B2 by a distance D7, the third aperture 124 is offset from the plane B2 by a distance D8, the fourth aperture 126 is offset from the plane B2 by a distance D9, and the fifth aperture 128 is offset from the plane B2 by a distance of D10. In one exemplary embodiment, D10>D9>D8>D7>D6 such that each of the apertures 120, 122, 124, 126, and 128 is offset a different distance from the surface 110 including, more specifically, the horizontal plane B2.

In one embodiment, each of the apertures 120, 122, 124, 126, and 128 can be offset by a constant distance from the pivot axis. More specifically, the apertures 120, 122, 124, 126, and 128 can be vertically aligned and offset a common distance from the pivot axis. In another embodiment, a center of each of the apertures 120, 122, 124, 126, and 128 is staggered to form a staggered array 112 of apertures. In this regard, a center of each of the apertures 120, 122, 124, 126, and 128 is offset by a different distance from the pivot axis, in an orientation similar to the array 48 of apertures of the riser 26 (FIG. 2).

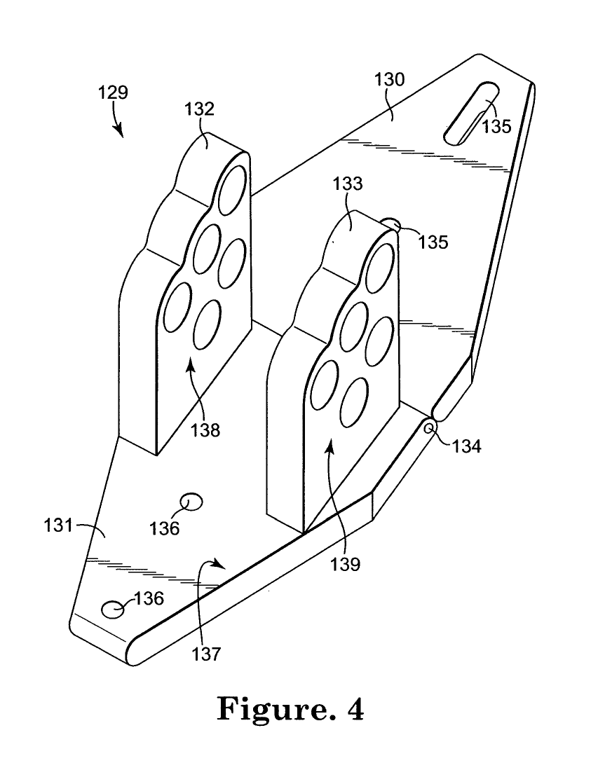

FIG. 4 is a perspective view of a hinge assembly 129 according to another embodiment of the present invention. In one embodiment, the hinge assembly 129 includes a first base plate 130, a second base plate 131, a first riser 132, and a second riser 133.

In one embodiment, the first base plate 130 is pivotally coupled to the second base plate 131 about a pivot axis coinciding with a hinge pin 134. In addition, in one exemplary embodiment, the first base plate 130 includes at least one mounting hole 135, and the second base plate 131 includes at least one mounting hole 136. The mounting holes 135 and 136 can each be a round hole or a through-slot adapted for receiving a mounting bolt or other fastener (not shown). In one exemplary embodiment, two mounting holes 135 are included on the first base plate 130 and two mounting holes 136 are included on the second base plate 131.

In one embodiment, the first riser 132 and the second riser 133 constitute a pair of spaced risers each extended from a surface 137 of the second base plate 131. In this regard, the first riser 132 is formed separate from, and spaced apart from, the second riser 133. In one embodiment, the first riser 132 and the second riser 133 are positioned on opposite sides of the second base plate 131.

In one embodiment, as illustrated in FIG. 4, the first riser 132 defines a first array 138 of apertures and the second riser 133 defines a second array 139 of apertures. In one embodiment, each of the first array 138 and the second array 139 of apertures defines a plurality of apertures with the first array 138 of apertures opposes and is aligned with the second array 139 of apertures.

In one embodiment, the first array 138 of apertures and the second array 139 of apertures are each arranged in a manner similar to the array 48 of apertures (FIG. 2) or the array 112 of apertures (FIG. 3) shown above. In particular, the first array 138 of apertures and the second array 139 of apertures are each configured such that, in one embodiment, each of the apertures is offset a different distance from the surface 137 of the second base plate 131, and each of the apertures is offset a different distance from the pivot axis.

A variety of embodiments for hinge assemblies have been described. In this regard, the following description of components of the hinge assembly 129 applies equally to components of the hinge assembly 20 (FIG. 1) and components of the hinge assembly 80 (FIG. 3). With particular reference to FIG. 4, the hinge assembly 129 includes the first base plate 130, the second base plate 131, and a riser including the risers 132 and 133. In one embodiment, the first base plate 130 is formed separately from the second base plate 131, and the risers 132 and 133 extend from one of the first base plate 130 or the second base plate 131. Although the risers 132 and 133 are shown extending from the second base plate 131, it should be understood that the risers 132 and 133 could extend from the first base plate 130.

In one embodiment, the risers 132 and 133 are formed separately from the base plate to which they are attached. For example, in one embodiment, the risers 132 and 133 are formed separately from each other and separately from the second base plate 131. As such, the risers 132 and 133 are attached to the second base plate 131. the risers 131 and 132 can be attached to the second base plate 131 by, for example, screws, bolts, adhesives, and/or thermoplastic welding. In another embodiment, the risers 132 and 133 extend from and are integrally formed with one of the first base plate 130 or the second base plate 131.

In one exemplary embodiment, the risers 132 and 133 the first base plate 130 and the second base plate 131 are formed of a plastic material. In this regard, while the risers 132 and 133, the first base plate 130, and the second base plate 131 are shown as uniformly solid, these components can be molded to include relief areas that facilitate molding or reduce material consumption as well as reinforcing ribs or projections that strengthen specific areas.

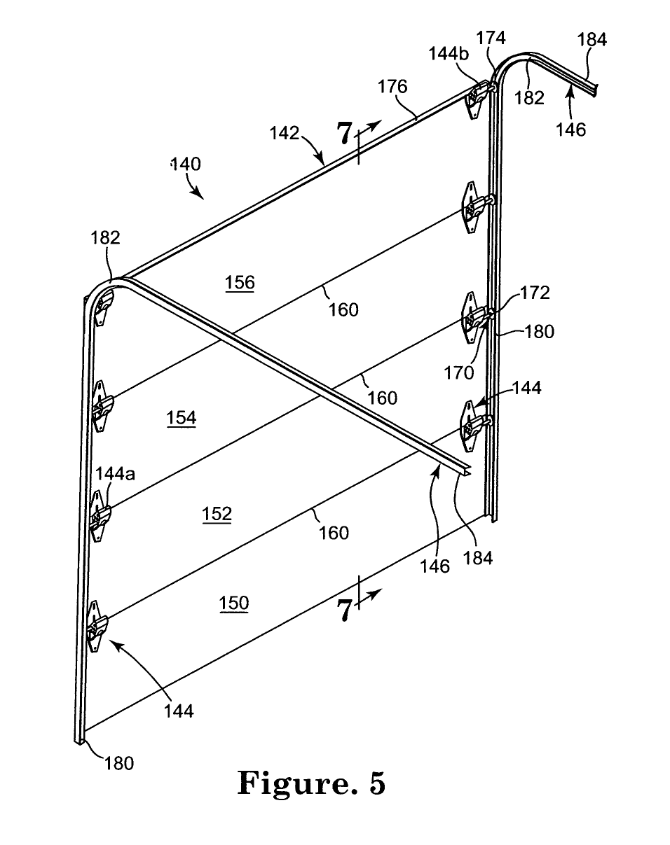

FIG. 5 is a perspective view of a door assembly 140 according to one embodiment of the present invention. The door assembly 140 includes a multi-panel door 142 including a plurality of guide roller assemblies 144 employed to support the door 142 within a track assembly 146.

In one exemplary embodiment, the multi-panel door 142 includes a first door panel 150, a second door panel 152, a third door panel 154, and a fourth door panel 156. Each of the panels 150, 152, 154, and 156 are hingeably coupled to an adjacent one of the panels 150, 152, 154, and 156 and including mating edges 160. While FIG. 5 depicts four door panels, it is to be understood that any number of door panels can be employed in forming the door assembly 140.

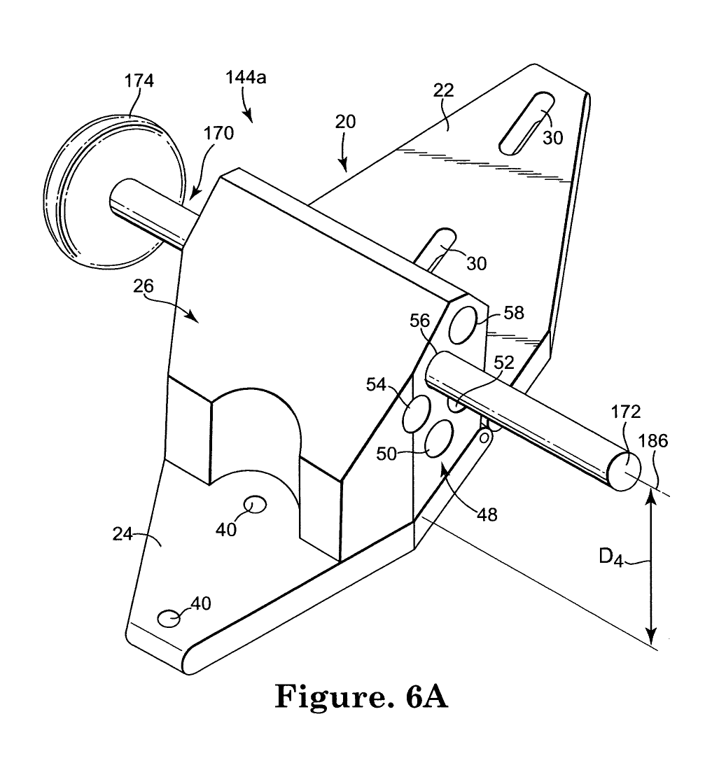

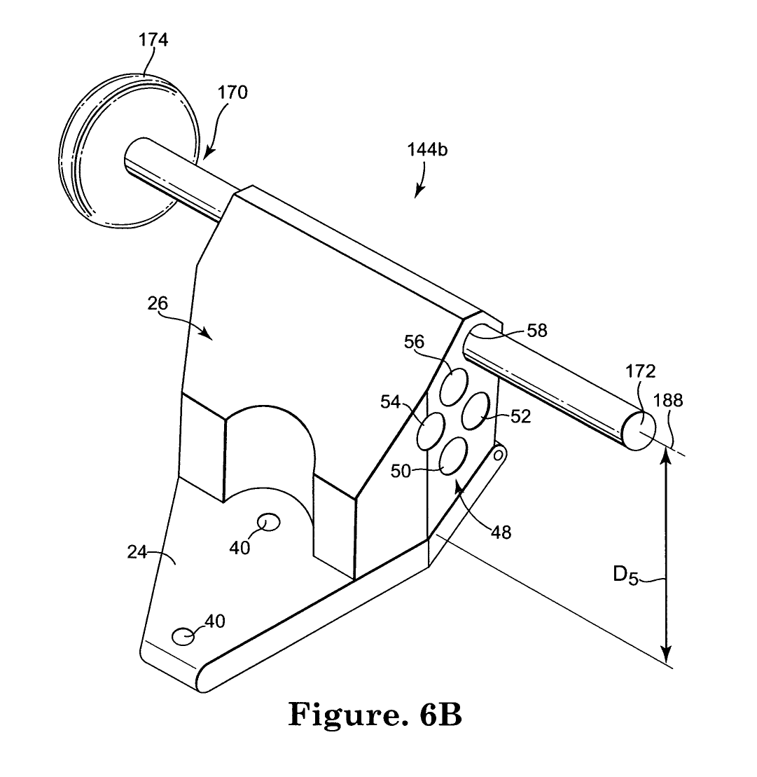

In one embodiment, each guide roller assembly 144 includes a hinge assembly, for example, the hinge assembly 20, the hinge assembly 80, or the hinge assembly 129, and a guide roller 170 shown in greater detail in FIG. 6A and FIG. 6B). In one embodiment, the guide roller 170 includes a guide roller pin 172 and a guide roller wheel 174.

In one embodiment, each guide roller assembly 144 is secured to two adjacent door panels and supports the door panels for travel along the track assembly 146. For example, in one embodiment, a guide roller assembly 144a is secured to the second door panel 152 and the third door panel 154 and the guide roller 170 is supported within the track assembly 146. In some configurations a guide roller assembly may be attached to only one door panel (i.e., a top panel) For example, where the fourth door panel 156 is a last or top door panel, a last guide roller assembly 144b is configured to support a top portion 176 of the fourth door panel 156 for travel along the track assembly 146. In this manner, the guide roller assemblies 144 support the door 142 for travel along the track assembly 146.

Regarding the guide roller assembly 144b, the first base plate 22 (FIG. 1) has been excluded. In this manner, the guide roller assembly 144b is configured for positioning along the top portion 176 of the fourth door panel 156. Since there is no vertically adjacent door panel above the fourth door panel 156, the guide roller assembly 144b is secured to the door 142 via attachment of the second base plate 24 to the fourth door panel 156.

In one embodiment, the track assembly 146 includes a vertical track section 180, a curved track section 182, and a horizontal track section 184 with the curved track section providing a transition between the vertical track section 180 and the horizontal track section 184. When the door 142 is in a down position (as shown in FIG. 5), the door 142 is vertically aligned and supported by the vertical track section 180. When the door 142 is retracted to an open position (not shown), the guide roller assemblies 144, and specifically the guide roller wheels 174, move along the track assembly 146 from the vertical track section 180 through the curved track section 182 to the horizontal track section 184. To this end, the guide roller wheels 174 roll within the track assembly 146 to permit the door 142 to move between a vertical or closed position and a horizontal or open position.

FIG. 6A illustrates one embodiment of the guide roller assembly 144a including the first base plate 22, the second base plate 24, and the riser 26 with the guide roller 170 supported within one the apertures. In particular, the guide roller pin 172 of the guide roller 170 is positioned within the aperture 56. In this regard, the guide roller pin 172 defines a longitudinal axis 186 that is coincident with a longitudinal axis of the aperture 56. With regard to the array 48 of apertures, the aperture 56 is offset an intermediate distance D4 from the second base plate 24.

FIG. 6B illustrates one embodiment of the guide roller assembly 144b including the second base plate 24 and the riser 26 extended from the second base plate 24 with the guide roller 170 supported within one of the apertures 48 of the riser 26. In particular, the guide roller pin 172 of the guide roller 170 is positioned within the aperture 58. In this regard, the guide roller pin 172 defines a longitudinal axis 188 that is coincident with a longitudinal axis of the aperture 58. With regard to the array 48 of apertures, the aperture 58 is offset a distance D5 from the second base plate 24. In one embodiment, and as shown in FIG. 6B, the aperture 58 is located the greatest distance from the second base plate 24 relative to the other apertures in the array 48 of apertures. Thus, when the guide roller pin 172 is positioned within the aperture 58, the guide roller 170 is offset from the base plate 24 by the greatest amount relative to the offset distances of the other apertures in the array 48 of apertures.

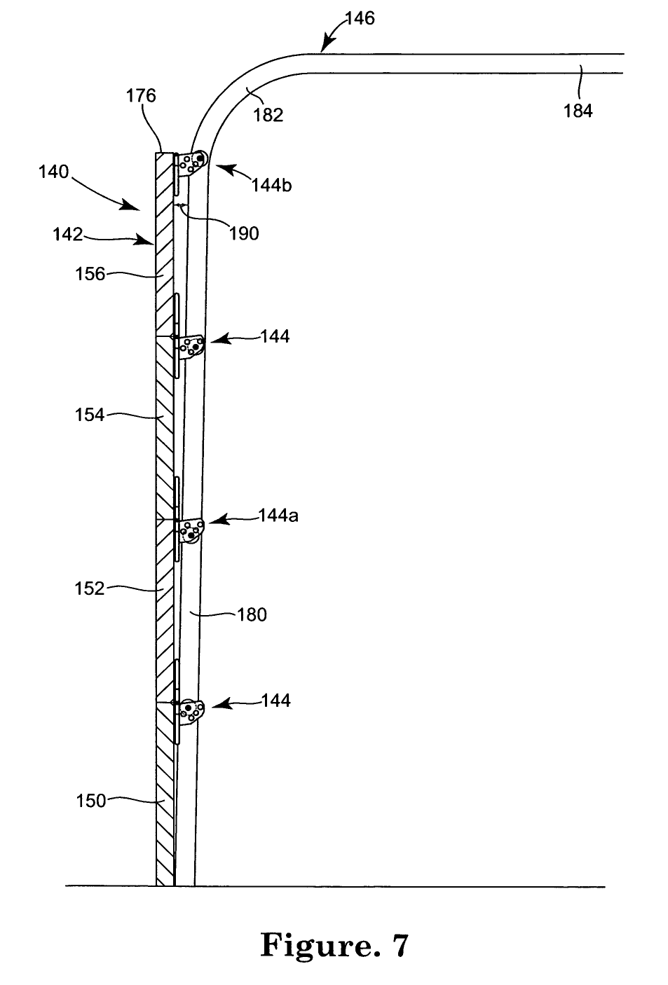

FIG. 7 illustrates a cross-sectional view of the door assembly 140 according to one embodiment of the present invention. The door 142 is supported within the track assembly 146 via the guide roller assemblies 144. As a point of reference, the track assembly 146 is configured such that the vertical track section 180 is tilted slightly away from a perfect vertical orientation (i.e., to the right with reference to FIG. 7). In this manner, the vertical track section 180 tilts slightly away from a perfect vertical orientation while the door 142 is vertically plumb when in the down position. More specifically, when the door 142 is in the vertical or closed position, the door 142 is maintained in a vertical orientation while the vertical track section 180 is slightly tilted off of vertical. As such, the panels of the door 142 travel upward and slightly inward during opening of the door 142.

To accommodate the vertical mounting of the door 142 into the slightly tilted track assembly 146, the guide roller assembly 144 can be mounted to any one of the door panels 150, 152, 154, and/or 156. For example, the guide roller assembly 144a (FIG. 6A) is coupled between the second door panel 152 and the third door panel 154 and configured to orient the guide roller 170 at an intermediate distance D4 from the second base plate 24. In this manner, the guide roller wheel 174 is supported within the vertical track section 180 such that the vertical orientation of the door 142 is maintained as the vertical track section 180 deviates from a perfect vertical orientation. In a similar manner, the guide roller assembly 144b (FIG. 6B) is configured such that the guide roller 170, and consequently the guide roller wheel 174, is offset a distance D5 from the second base plate 24. In one embodiment, the distance D5 is greater than the distance D4 such that the fourth door panel 156 remains vertical when supported by the slightly tilted vertical track section 180. In this manner, the guide roller assembly 144b orients the door panel 156 to a vertical position that is offset from the slightly tilted vertical section 180 of the track assembly 146.

A method of supporting a door assembly 140 to facilitate opening and closing of the door 142 is now described with reference to FIG. 5 through FIG. 7. During installation, pairs of guide roller assemblies 144 are sequentially secured to adjacent panels of the door 142 and supported by the track assembly 146. With reference to FIG. 6A, the guide rollers 170 of the guide roller assemblies 144 are selectively positioned within one of the apertures in the array 48 of apertures. For example, for guide roller assemblies 144 disposed adjacent to the first door panel 150 and the second door panel 152, the guide rollers 170 are positioned within apertures closer to the second base plate 24. Guide rollers 170 disposed in apertures relatively close to the second base plate 24 will result in the adjacent door panels (for example the first door panel 150 and the second door panel 152) being positioned closer to the vertical track section 180.

In contrast, and with reference to FIG. 6B, positioning of the guide rollers 170 within apertures further from the second base plate will result in the adjacent door panels (for example, the third door panel 154 and the fourth door panel 156) being positioned further from the vertical track section 180. With this arrangement of guide roller assemblies 144, the fourth door panel 156 will be offset from the track assembly 146 by the offset distance 190. Consequently, the door 142 is adapted to travel in an unimpeded manner upward and slightly inward from the vertical closed position to the horizontal open position. In addition, when closing the door assembly 140, the door 142 will be offset from the tilt of the track assembly 146 such that the door 142 is plumb to the doorway (not shown) when in the closed position. With roller guide assemblies 144, as described above, an installer of a door assembly is able to mount a door within a slightly tilted track assembly without having to rely on numerous guide roller assemblies each of varying spacing.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A hinge assembly, comprising:
a first base plate;
a second base plate pivotally coupled to the first base plate about a pivot axis; and
a riser extending from a surface of one of the first base plate and the second base plate,
wherein the riser defines a plurality of apertures, and
wherein each of the apertures is offset from the pivot axis and spaced a different distance from the surface of the one of the first base plate and the second base plate.

2. The hinge assembly of claim 1, wherein the first base plate has a first scarf end and the second base plate has a second scarf end, wherein the first scarf end and the second scarf end are pivotally coupled about the pivot axis.

3. The hinge assembly of claim 1, wherein the riser includes two spaced risers extended from the surface of the one of the first base plate and the second base plate.

4. The hinge assembly of claim 3, wherein each of the two risers define a plurality of opposing and aligned apertures.

5. The hinge assembly of claim 1, wherein the riser includes a single riser extended between opposite sides of the one of the first base plate and the second base plate.

6. The hinge assembly of claim 1, wherein the riser is integrally formed with the one of the first base plate and the second base plate.

7. The hinge assembly of claim 1, wherein the riser is formed separately from and secured to the one of the first base plate and the second base plate.

8. The hinge assembly of claim 1, wherein each of the apertures has a longitudinal axis spaced from and oriented substantially parallel with the pivot axis.

9. The hinge assembly of claim 1, wherein each of the apertures is spaced a different distance from the pivot axis.

10. The hinge assembly of claim 1, wherein one of the apertures is spaced a first distance from the surface of the one of the first base plate and the second base plate, and another of the apertures is spaced a second distance from the surface of the one of the first base plate and the second base plate, wherein the second distance is greater than the first distance.

11. The hinge assembly of claim 1, wherein the riser defines a plurality of sleeves, wherein each of the sleeves defines one of the apertures.

12. The hinge assembly of claim 1, wherein each of the first base plate and the second base plate has at least one mounting hole formed therein.

13. The hinge assembly of claim 1, wherein at least one of the first base plate, the second base plate, and the riser are formed of a plastic material.

14. The hinge assembly of claim 1, wherein each of the apertures is adapted to receive a guide roller pin.

15. A hinge assembly adapted to support a guide roller, the hinge assembly comprising:
a first base plate;
a second base plate pivotally coupled to the first base plate about a pivot axis; and
means for supporting the guide roller in one of a plurality of positions each offset from the pivot axis and spaced a different distance from one of the first base plate and the second base plate.

16. The hinge assembly of claim 15, wherein means for supporting the guide roller includes a riser extended from a surface of one of the first base plate and the second base plate, wherein the riser includes a plurality of apertures each defining one of the plurality of positions.

17. A guide roller assembly, comprising:
a base plate;
a riser extending from a surface of the base plate, the riser defining a plurality of apertures each offset a different distance from the surface of the base plate; and
a guide roller including a guide roller pin, and a guide roller wheel supported by the guide roller pin,
wherein each of the apertures is adapted to selectively receive the guide roller pin of the guide roller.

18. The guide roller assembly of claim 17, further comprising:
another base plate pivotally coupled to the base plate about a pivot axis, wherein each of the apertures is offset from the pivot axis.

19. A method of supporting a multi-panel door, the method comprising:
providing a first guide roller assembly and a second guide roller assembly each including at least one base plate and at least a first aperture and a second aperture each offset a different distance from the at least one base plate;
supporting a first guide roller in the first aperture of the first guide roller assembly and securing the at least one base plate of the first guide roller assembly to a first panel of the multi-panel door; and
supporting a second guide roller in the second aperture of the second guide roller assembly and securing the at least one base plate of the second guide roller assembly to a second panel of the multi-panel door.

20. The method of claim 19, wherein supporting the first guide roller includes spacing the first guide roller a first distance from a plane of the multi-panel door, and wherein supporting the second guide roller includes spacing the second guide roller a second distance from the plane of the multi-panel door, wherein the second distance is greater than the first distance.
